(19) United States
(12) Patent Application Publication
(10) Pub. No.: US 2007/0263351 A1
(43) Pub. Date: Nov. 15, 2007

(54) Electronic apparatus

(75) Inventors: Chi-Chung Ho, Taipei (TW); Jung-Kun Lai, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/798,431

(22) Filed: May 14, 2007

(30) Foreign Application Priority Data
May 15, 2006 (TW) 095117169

(51) Int. Cl. G06F 1/16

(52) U.S. Cl. 361/685

(57) ABSTRACT

An electronic apparatus includes a main body, a protective casing, a removable device, and a buffer member. In this case, the main body has an accommodation portion with at least a first sidewall. The protective casing is disposed in the accommodation portion, and has an inner portion and an outer portion. The removable device is disposed in the inner portion of the protective casing. The buffer element is disposed on the outer portion of the protective casing, and is disposed between the protective casing and the first sidewall.

### BACKGROUND OF THE INVENTION

1. Field of Invention

The invention relates to an electronic apparatus and, in particular, to an electronic apparatus with a buffer element.

2. Related Art

In general, the hard disk drive (HDD) is one of the important devices in a computer and is used for storing data and files to be accessed. However, the data storage area of HDD may be damaged due to vibration.

Referring to FIG. 1, an HDD 10 is roughly rectangular and has several screw holes 101 disposed at its sides. A plurality of first screws 12 are utilized to fasten the HDD 10 to an accommodation base 11. Then, the accommodation base 1 fastened to the HDD 10 is screwed into a casing 14 with a plurality of second screws 13.

When the casing 14 is shaken, the vibration will be transmitted to the HDD 10 through the second screws 13, accommodation base 11 and first screws 12. Therefore, it is possible to damage the data stored in the HDD 10.

In addition, the HDD 10 is first screwed into the accommodation base 11 with the first screws 12 and the accommodation base 11 is then screwed into the casing 14. These assembling processes are complex and require a lot of time and labor.

### SUMMARY OF THE INVENTION

In view of the foregoing, the invention is to provide an electronic apparatus, which can provide a better cushioning effect for removable devices installed therein.

To achieve the above, an electronic apparatus of the invention includes a main body, a protective casing, a removable device, and a buffer element. The main body has an accommodation portion, which includes at least a first sidewall. The protective casing is disposed in the accommodation portion and has an inner portion and an outer portion. The removable device is disposed in the inner portion of the protective casing. The buffer element, which is disposed on the outer portion of the protective casing, is located between the protective casing and the first sidewall.

As mentioned above, the buffer element of the invention is located between the protective casing and the main body, and can be connected with the protective casing by a covering way or a clipping way. When the electronic apparatus is shaken by an external force, the buffer element can absorb the external force so as to avoid transmitting it directly to the removable device. Thus, the removable device can be prevented from damage. In addition, first and second stopping members can fix the buffer element, so that the protective casing can be stably fastened in the main body. Compared with the conventional structure, the invention can avoid transmitting vibration directly to the removable device, and thus reduce the possibility of damaging the removable device.

### BRIEF DESCRIPTION OF THE DRAWINGS

The invention will become more fully understood from the detailed description given herein below illustration only, and thus is not limitative of the present invention, and wherein:

FIG. 1 is a schematic diagram of the conventional electronic apparatus;

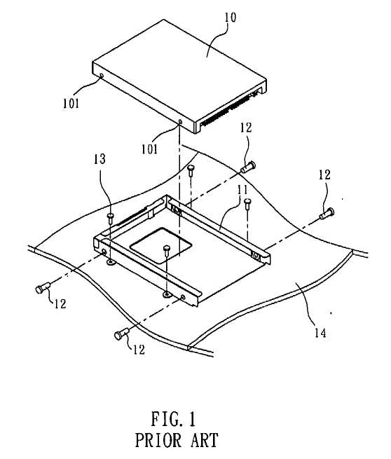

FIG. 2 is an exploded view of an electronic apparatus according to a preferred embodiment of the invention;

FIG. 3 is a three-dimensional diagram showing the electronic apparatus according to this embodiment of the invention; and

FIG. 4 is a sectional diagram along the line A-A of FIG. 2.

### DETAILED DESCRIPTION OF THE INVENTION

The present invention will be apparent from the following detailed description, which proceeds with reference to the accompanying drawings, wherein the same references relate to the same elements.

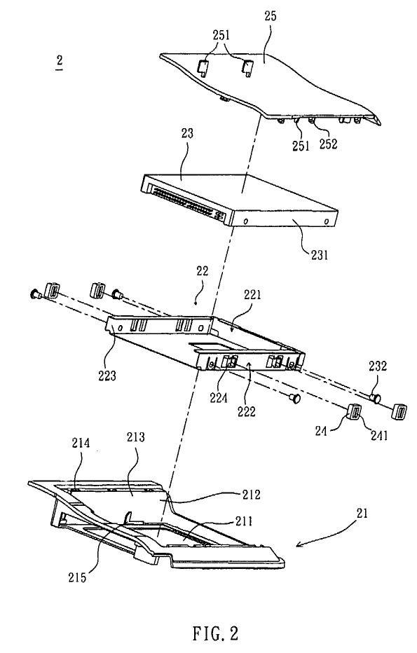

With reference to FIG. 2, an electronic apparatus 2 according to a preferred embodiment of the invention includes a main body 21, a protective casing 22, a removable device 23, and buffer elements 24. The main body 21 has an accommodation portion 211, which has an opening 212 and at least a first sidewall 213. The protective casing 22, which has an inner portion 221 and an outer portion 222, is disposed in the accommodation portion 211. The removable device 23 is disposed in the inner portion 221 of the protective casing 22. The buffer element 24, which is disposed on the outer portion 222 of the protective casing 22, is located between the protective casing 22 and the first sidewall 213.

In this embodiment, the electronic apparatus 2 can be, but is not limited to, a notebook computer.

In addition, referring to FIG. 2 again, the main body 21 of the embodiment can be a casing of a notebook computer. Herein, FIG. 2 only illustrates a part of the notebook computer's casing as the main body 21. Furthermore, a plurality of first connecting portions 214 can be disposed on the top of the first sidewall 213. In this case, the first connecting portions 214 are locking holes. Of course, the locations and aspects of the first connecting portions 214 can be modified based on real needs.

Moreover, the main body 21 may further include a plurality of first stopping members 215 disposed on the first sidewall 213. In the embodiment, the first stopping members 215 are roughly L-shaped. Of course, the locations and aspects of the first stopping portions 215 can be modified based on real needs.

With reference to FIG. 2 again, the protective casing 22 of the embodiment is disposed in the accommodation portion 211. In the embodiment, the protective casing 22 may be a metal casing and have at least a second sidewall 223. In addition, the protective casing 22 may have a plurality of supporting members 224 disposed at an outer portion 222 of the second sidewall 223 of the protective casing 22. Each supporting member 224 can be formed on the second sidewall 223 by punching.

As shown in FIG. 2, the removable device 23 of the embodiment is disposed in an inner portion 221 of the protective casing 22. In addition, the removable device 23 further has at least a third sidewall 231. In this embodiment, the removable device 23 is, for example, a hard disk drive (HDD), which is roughly rectangular. The third sidewall 231 is opposite to the second sidewall 223 of the protective casing 22. In this case, the protective casing 22 covers at least one part of the removable device 23. Furthermore, to connect the removable device 23 with the protective casing 22 more stable, a plurality of locking elements 232 are used to fasten the removable device 23 to the protective casing 22.

Referring to FIG. 2, the buffer element 24 of the embodiment is disposed at the outer portion 222 of the protective casing 22, and is located between the protective casing 22 and the first sidewall 213. The buffer element 24 can be made of an elastic material such as rubber. In addition, the buffer element 24 can be disposed on the second sidewall 223 of the protective casing 22 by a covering way. In detailed, the buffer element 24 has a hole 241, and the supporting member 224 passes through the hole 241. Alternatively, the buffer element 24 can be adhered to the outer portion 222 of the protective casing 22 with glue (not shown). Moreover, the shape of the supporting member 224 of the protective casing 22 may be changed, so that the buffer element 24 can be fixed on the outer portion 222 of the protective casing 22 by other methods.

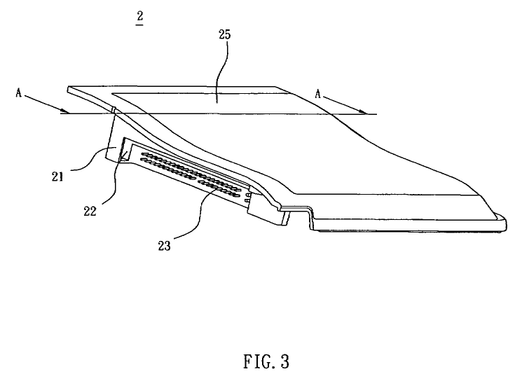

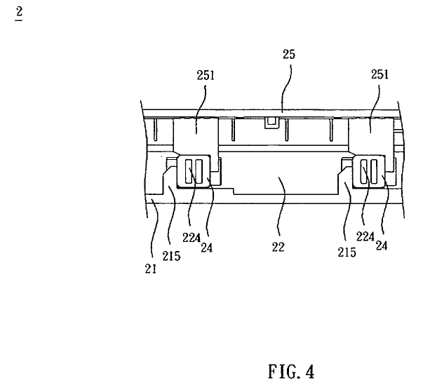

FIG. 3 is a three-dimensional diagram showing the electronic apparatus according to the embodiment of the invention. FIG. 4 is a sectional diagram of FIG. 2 along the line A-A. With reference to FIG. 2, FIG. 3 and FIG. 4, the electronic apparatus 2 of the embodiment further includes a cover 25, which covers the opening 212 of the accommodation portion 211 of the main body 21. The cover 25 further has a plurality of second stopping members 251, which are roughly L-shaped. When the cover 25 covers the main body 21, the second stopping member 251 and the first stopping member 215 are positioned at opposite two sides of the buffer element 24. Accordingly, the buffer elements 24 are restricted by the first stopping members 215 and the second stopping members 251, and thus the protective casing 22 can be fastened in the accommodation portion 211 of the main body 21.

As shown in FIG. 2, the cover 25 may further include a plurality of second connecting portions 252. In this embodiment, the second connecting portions 252 are hooks for connecting with the first connecting portions 214 of the main body 21. Therefore, the cover 25 can stably cover the opening 212 of the accommodation portion 211. Of course, to enhance the fastening effect, a locking element (not shown) can be used to lock the cover with the main body 21.

When the electronic apparatus 2 is shaken, the vibration will transmit from the main body 21 to the buffer element 24. Then, the buffer element 24 absorbs the vibration, so that the external force is unable to reach the removable device 23 directly. In addition, the first stopping member 215 and the second stopping member 251 are located at two sides of the removable device 23, so the protective casing 22 can be stably disposed in the accommodation portion 211 of the main body 21. Thus, the removable device 23 is not easily damaged by vibration.

In summary, the buffer element of the invention is located between the protective casing and the main body, and can be connected with the protective casing by way of covering, adhering or clipping. Once the electronic apparatus is shaken by external force, the buffer element can absorb the external force so as to avoid transmitting it directly to the removable device. Thus, the removable device can be prevented from damage. In addition, first and second stopping members can fix the buffer element, so that the protective casing can be stably fastened in the main body. Compared with the conventional structure, the invention can avoid transmitting vibration to the removable device directly, and thus reduce the possibility of damaging the removable device.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An electronic apparatus, comprising:
a main body having an accommodation portion with at least a first sidewall;
a protective casing disposed in the accommodation portion and having an inner portion and an outer portion;
a removable device disposed in the inner portion of the protective casing; and
a buffer element disposed on the outer portion of the protective casing, wherein the buffer element is located between the protective casing and the first sidewall.

2. The electronic apparatus according to claim 1, further comprising a cover for covering an opening of the accommodation portion.

3. The electronic apparatus according to claim 1, wherein the protective casing is a metal casing for covering at least a part of the removable device.

4. The electronic apparatus according to claim 1, wherein the protective casing further has at least a second sidewall, the removable device further has at least a third sidewall opposite to the second sidewall, and the buffer element is disposed on the third sidewall.

5. The electronic apparatus according to claim 4, wherein the buffer element is disposed on the third sidewall by way of covering, adhering, or clipping.

6. The electronic apparatus according to claim 1, wherein the removable device is connected with the protective casing with a screwing element.

7. The electronic apparatus according to claim 1, wherein the buffer element is made of an elastic material.

8. The electronic apparatus according to claim 1, wherein the buffer element is made of rubber.

9. The electronic apparatus according to claim 1, wherein the removable device is a hard disk drive (HDD).
